(19) United States
(12) Patent Application Publication
(10) Pub. No.: US 2014/0307100 A1
(43) Pub. Date: Oct. 16, 2014

(54) ORTHOGRAPHIC IMAGE CAPTURE SYSTEM

(71) Applicants: Kari MYLLYKOSKI, Austin, TX (US); Dejan Jovanovic, Austin, TX (US); Keith Bearmore, Santa Fe, NM (US)

(72) Inventors: Kari MYLLYKOSKI, Austin, TX (US); Dejan Jovanovic, Austin, TX (US); Keith Bearmore, Santa Fe, NM (US)

(21) Appl. No.: 13/861,534

(22) Filed: Apr. 12, 2013

(51) Int. Cl. H04N 5/232

(52) U.S. Cl. CPC H04N 5/23296
USPC 348/169

(57) ABSTRACT

An image capture system for an image data capture and processing system, consisting of a digital imaging device, active illumination source, computer and software that generates 2 dimensional data sets from which real world coordinate information with planarity, scale, aspect, and innate dimensional qualities can be extracted from the captured image in order to transform the image data into other geometric perspectives and to extract real dimensional data from the imaged objects. The image transformations may be homographic transformations, orthographic transformations, perspective transformations, or other transformations that takes into account distortions in the captured image caused by the camera angle.

### RELATED APPLICATION

This application is a utility application claiming priority of U.S. provisional application(s) Ser. No. 61/623,178 filed on 12 Apr. 2012 and Ser. No. 61/732,636 filed on 3 Dec. 2012.

### TECHNICAL FIELD OF THE INVENTION

The present invention generally relates to optical systems, more specifically to optical systems for changing the view of a photograph from one viewing angle to a virtual viewing angle, more specifically to changing the view of a photograph to a dimensionally correct orthographic view and more specifically to extract correct dimensions of objects from photographic images.

### BACKGROUND OF THE INVENTION

The present invention relates generally to and more specifically it relates to an image data capture and processing system, consisting of a digital imaging device, active illumination source, computer and software that generates 2 dimensional data sets from which real world coordinate information with planarity, scale, aspect, and innate dimensional qualities can be extracted from the captured image in order to transform the image data into other geometric perspectives and to extract real dimensional data from the imaged objects. The image transformations may be homographic transformations, orthographic transformations, perspective transformations, or other transformations that takes into account distortions in the captured image caused by the camera angle.

In the following specification, we use the name Orthographic Image Capture System to refer to a system that extracts real world coordinate accurate dimensional data from imaged objects. Although the Orthographic transformation is one specific type of transformation that might be used, there are a number of similar geometric transformations that can also be used without changing the design and layout of the Orthographic Image Capture System.

There is a need for an improved optical system for changing the view of an image from an actual viewing angle to a virtual viewing angle. There is a need for using such a system to create dimensionally correct views of an image from an image taken from a non-orthographic viewing angle. There is a need to be able to extract dimensional information of the object images taken from a non-orthographical viewing angle.

### BRIEF SUMMARY OF THE INVENTION

The invention generally relates to a 2 dimensional textures with applied transforms which includes a digital imaging sensor, an active illumination device, a calibration system, a computing device, and software to process the digital imaging data.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an orthographic image capture system for an image data capture and processing system, consisting of a digital imaging device, active illumination source, computer and software that generates 2d orthographic data sets, with planarity, scale, aspect, and innate dimensional qualities.

Another object is to provide an Orthographic Image Capture System that allows a digital camera or imager data to be optically corrected, by using a software system, for a variety of lens distortions.

Another object is to provide an Orthographic Image Capture System that has an active illumination device mounted to the digital imaging device in a secure and consistent manner, with both devices emitting and capturing data within a common field of view.

Another object is to provide an Orthographic Image Capture System that has a computer and software system that triggers the digital imager to capture an image, or series of images in which the active illumination data is also present.

Another object is to provide an Orthographic Image Capture System that has a computer and software system that integrates digital imager data with active illumination data, synthesizing and creating a 2 dimensional image with corrected planarity and orthographically rectified information.

Another object is to provide an Orthographic Image Capture System that has a computer and software system that integrates digital imager data with active illumination data, synthesizing and creating a 2 dimensional image with a scalar information, aspect ratio and dimensional qualities of pixels within scene at the distance point of planarity during image capture.

Another object is to provide an Orthographic Image Capture System that has a software system that integrates the planarity, scalar, and aspect information, to create a corrected data set, that can be exported in a variety of common file formats.

Another object is to provide an Orthographic Image Capture System that has a software system that creates additional descriptive notation in or with the common file format, to describe the image pixel scalar, dimension and aspect values, at a point of planarity.

Another object is to provide an Orthographic Image Capture System that has a software system that displays the corrected image.

Another object is to provide an Orthographic Image Capture System that has a software system can export the corrected data set, and additional descriptive notation.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates top down view of a an orthographic image capture system capturing an orthographic image of a wall with three windows;

FIG. 2 illustrates a captured image taken from a non-orthographic viewing angle;

FIG. 3 illustrates a virtual orthographic image of the wall created from the image captured from a non-orthographic camera angle;

FIG. 4 illustrates in greater scale the illumination pattern shown in FIG. 2 and FIG. 3;

FIG. 5 illustrates an alternative illumination pattern;

FIG. 6 illustrates an alternative illumination pattern;

FIG. 7 illustrates an alternative illumination pattern;

FIG. 8 illustrates an alternative illumination pattern;

FIG. 9 illustrates an alternative illumination pattern;

FIG. 10 illustrates an alternative illumination pattern;

FIG. 11 illustrates an alternative illumination pattern;

FIG. 12 illustrates an upper perspective view of an embodiment of a system with a single Camera and single Active Illumination configured in a common housing;

FIG. 13 illustrates an upper perspective view of an embodiment of a system with a single Camera and dual Active Illumination configured in a common housing;

FIG. 14 illustrates an upper perspective view of an embodiment of a system with a single Camera and Active Illumination configured in individual housings, with adaptor to fix the relative relationship of the housings;

FIG. 15 illustrates an upper perspective view of an embodiment of a system with a single Camera and dual Active Illumination configured in individual housings, with adaptor to fix relative relationship of the housings;

FIG. 16 illustrates an upper perspective view of an embodiment of a system with dual Cameras and dual Active Illumination configured in individual housings, with adaptor to fix relative relationship of the housings in a horizontal arrangement;

FIG. 17 illustrates an upper perspective view of an embodiment of a system with dual Cameras and dual Active Illumination configured in individual housings, with adaptor to fix relative relationship of the housings in vertical arrangement;

FIG. 18 illustrates an upper perspective view of an embodiment of a system with a single Camera and dual Active Illumination configured in individual housings, with adaptor to fix relative relationship in vertical arrangement;

FIG. 19 illustrates an upper perspective view of an embodiment of a system with dual Cameras and Active Illumination configured in individual housings, with adaptor to fix relative relationship of the housings in a vertical arrangement;

FIG. 20 illustrates an embodiment of data processing flow for generating the desired transformed image from the non-transformed raw image;

FIG. 21 illustrates an embodiment of data processing flow for generating correct world coordinate dimensions from a non-transformed raw image;

FIG. 22 illustrates an embodiment with an example of dimensional data which can be extracted from the digital image;

FIG. 23 illustrates the undistorted active illumination pattern of FIG. 4;

FIG. 24 illustrates the distorted active illumination pattern of FIG. 4 for a camera angle like the angle illustrated in FIG. 1;

FIG. 25 illustrates the distorted active illumination pattern of FIG. 4 for a camera angle like the angle illustrated in FIG. 1 but lowered so that it was looking up at the wall; and

FIG. 26 illustrates the pixel mapping of the distortion ranges of the pattern illustrated in FIG. 4 and FIG. 23.

### DETAILED DESCRIPTION OF THE INVENTION

Preferred embodiments of the present invention are illustrated in the FIGUREs, like numerals being used to refer to like and corresponding parts of the various drawings.

The present invention generally relates to an improved optical system for changing the view of an image from an actual viewing angle to a virtual viewing angle. The system creates orthographically correct views of an image as well as remapping the image coordinates into a set of geometrically correct world coordinates from an image taken from an arbitrary viewing angle. The system also extracts dimensional information of the object imaged from images of the object taken from an arbitrary viewing angle.

### A. Overview

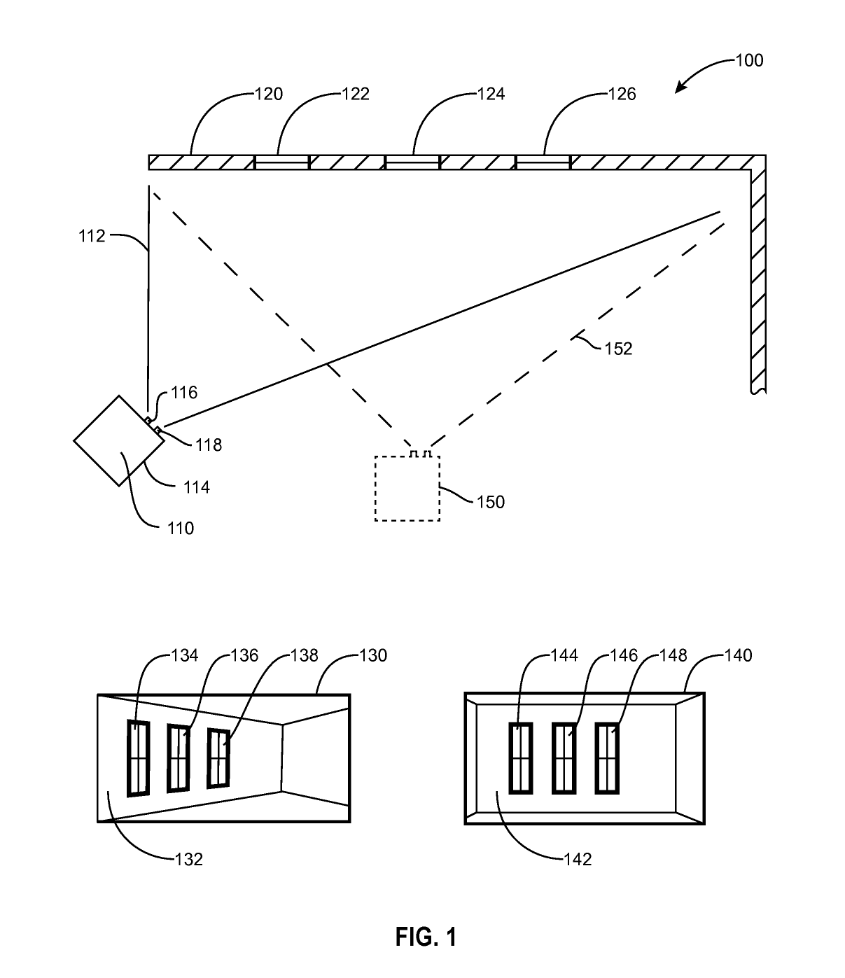

FIG. 1 illustrates an object (a wall 120 with windows 122, 124, 126) being captured 100 in photographic form by an orthographic image capture system 110. FIG. 1 also illustrates two images 130 and 140 of the object 120 generated by the orthographic image capture system. The first image 130 is a conventional photographic image of the object 120 taken from a non-orthographic arbitrary viewing angle 112. The second image 140 is a view of the object 120 as would be seen from a virtual viewing angle 152. In this case the virtual viewing angle 152 is an orthographic viewing angle of the object as would be seen from a virtual camera 150. In view 130 the object (wall 120 with windows 122, 124, 126) are seen in a perspective view as wall 132, and windows 134, 136, and 138: the farthest window 138 appears smallest. In the orthographic view 140, object (wall 120 with windows 122, 124, 126) are seen in an orthographic perspective as wall 132, and windows 134, 136, and 138: the windows which are the same size appear to be the same size in this image.

The components of the orthographic image capture system 110 illustrated in FIG. 1 include the housing 114, a digital imaging optics and sensor (camera 116), and an active illumination device 118. The calibration system, computing device, and software to process the image data are discussed below.

### B. Camera

The camera 116 is optical data capture device, with the output being preferably having multiple color fields in a pattern or array, and is commonly known as a digital camera. The camera function is to capture the color image data within a scene, including the active illumination data. In other embodiments a black and white camera would work, almost as well, as well or in some cases better than a color camera. In some embodiments of the orthographic image capture system, it may be desirable to employ a filter on the camera that enhances the image projected by the active illumination device for the optical data capture device.

The camera 116 is preferably a digital device that directly records and stores photographic images in digital form. Capture is usually accomplished by use of cameral optics (not shown) which capture incoming light and a photosensor (not shown), which transforms the light amplitude and frequency into colors. The photosensors are typically constructed in an array, that allows for multiple individual pixels to be generated, with each pixel having a unique area of light capture. The data from the multiple array of photosensors is then stored as an image. These stored images can be uploaded to a computer immediately, stored in the camera, or stored in a memory module.

The camera may be a digital camera, that stores images to memory, That transmits images, or otherwise makes image data available to a computing device. In some embodiments, the camera shares a housing with the computing device. In some embodiments, the camera includes a computer that performs preprocessing of data to generate and imbed information about the image that can later be used by the onboard computer and/or an external computer to which the image data is transmitted or otherwise made available.

### C. Active Illumination

The active illumination device in the one several embodiments is an optical radiation emission device. The emitted radiation shall have some form of beam focusing to enable precision beam emission—such as light beams generated by a laser. The function is to emit a beam, or series of beams at a specific color and angle relative to the camera element. The active illumination has fixed geometric properties, that remain static in operation.

However, in other embodiments, the active illumination can be any source that can generate a beam, or series of beams that can be captured with the camera. Provided that the source can produce a fixed illumination pattern, that once manufactured, installed and calibrated does not alter, move, modulate, or change geometry in any way. The fixed pattern of the illumination may be a random or fixed geometric pattern, that is of known and predefined structure. The illumination pattern does not need to be visible to the naked eye provided that it can be captured by the camera for the software to detect its location in the image as further described below.

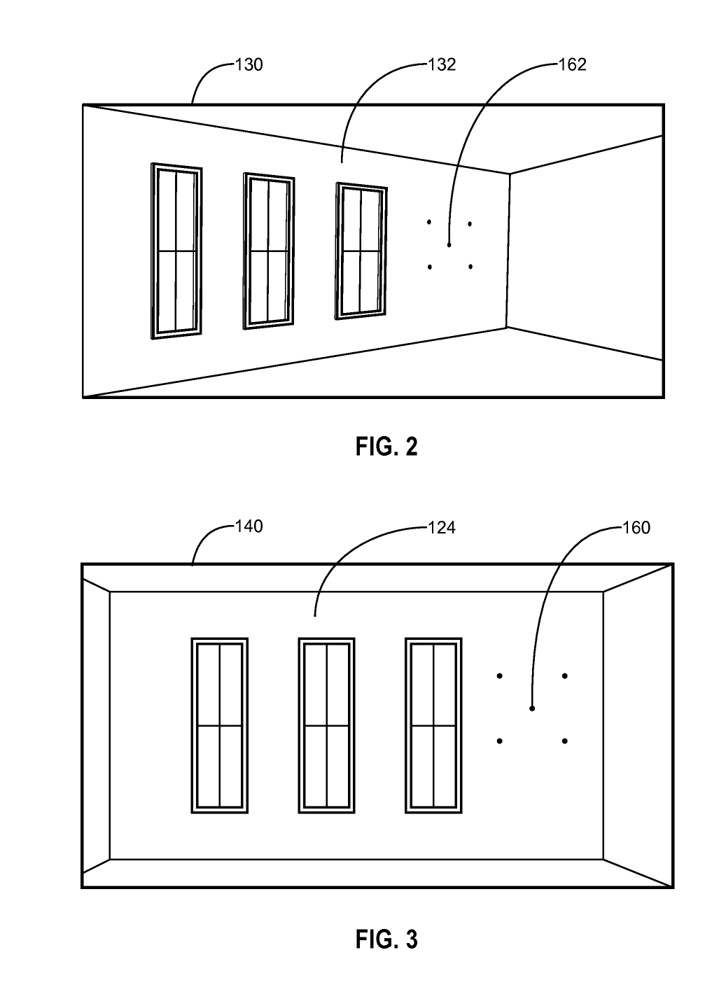

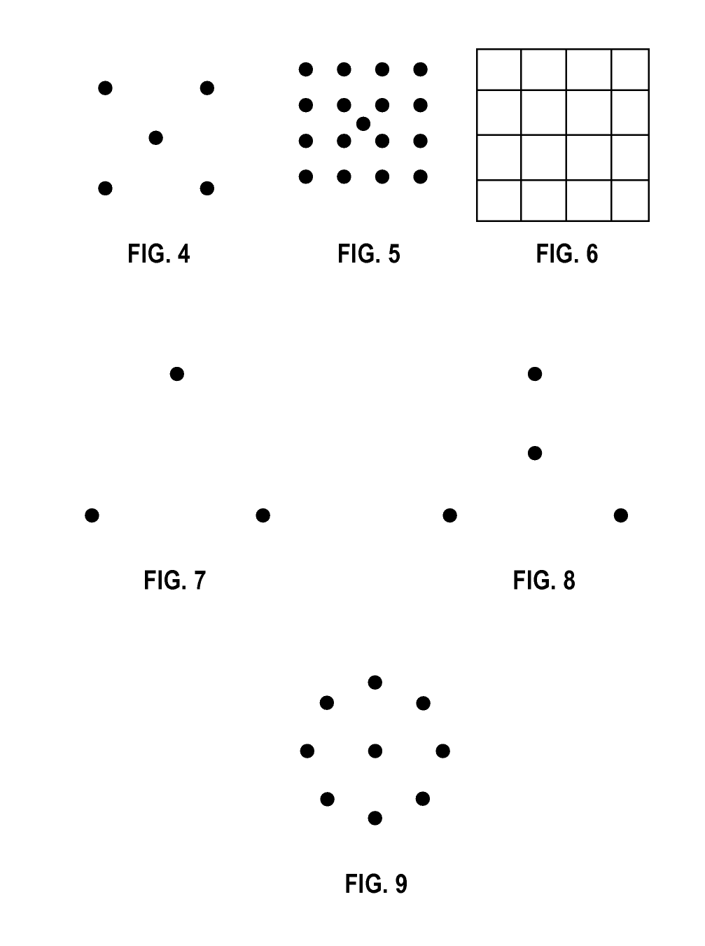

The illumination pattern generated by the active illumination device 118 is not illustrated in FIG. 1. FIG. 2 and FIG. 3 illustrate the images 130 and 140 respectively from FIG. 1 in greater detail. Specifically these illustrations include illustrations of the pattern 162 and 160 respectively of the projected by the active illumination device 118. However an embodiment of a pattern 160 and 162 is illustrated in FIG. 2 and FIG. 3. The pattern shown in greater detail in FIG. 4 is the same pattern projected in FIG. 2 and FIG. 3. FIG. 2 illustrates how the camera sees the pattern 162; while, FIG. 3 illustrates how the pattern looks (ideally as projected) when the orthographic imaging system creates a virtual orthographic view of the object from the non-orthographic image with the image coordinates transformed into dimensionally corrected and oriented world coordinates.

As previously mentioned FIG. 4 illustrates an embodiment of a projection pattern. This pattern is good for capturing orthographic images of a two-dimensional object. Such as the wall 120 in FIG. 1. Note that the non-orthographic view angle is primarily non-orthographic in one dimension: pan angle of the camera. In other uses of the system the tilt angle or both the pan and tilt angle of the camera may be non-orthographic. The pattern shown in FIG. 4 provides enough information in all three non-orthographic conditions: pan off angle, tilt off angle or both pan and tilt off angle.

FIG. 5, FIG. 6, FIG. 7, FIG. 8, and FIG. 9 also illustrate examples of the limitless patterns that can be used. However, in embodiments that also make orthographic corrections to an image captured by a camera, based on the distortions caused the camera's optic system, patterns with more data points such as FIG. 5 and particularly FIG. 6 may be more desirable.

The illumination source 118 may utilize a lens system to allow for precision beam focus and guidance, a diffraction grating, beam splitter, or some other beam separation tool, for generation of multi path beams. A laser is a device that emits light (electromagnetic radiation) through a process of optical amplification based on the stimulated emission of photons. The emitted laser light is notable for its high degree of spatial and temporal coherence, unattainable using other technologies. A focused LED, halogen, or other radiation source may be utilized as the active illumination source.

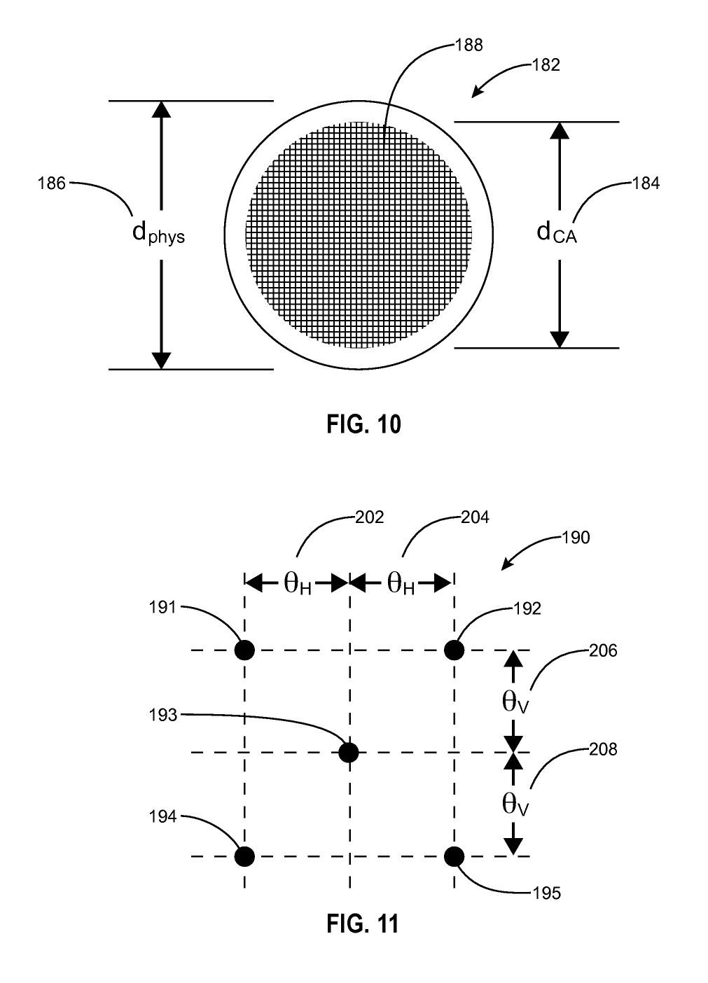

FIG. 10 and FIG. 11 illustrate in greater detail the creation of the pattern illustrated in FIG. 4. In a typical embodiment of the systems described herein, the pattern is generated by placing a diffraction grating in front of a laser diode. FIG. 10 illustrates a Diffractive Optical Element, (DOE) for generating the desired pattern. In an embodiment of the active illumination system 118, the DOE 180 has an active diffraction area 188 diameter of about 5 mm, a physical size of about 7 mm. And a thickness between 0.5 and 1 mm. The DOE is placed before a red laser diode with a nominal wavelength of 635 nm with an expected range of 630-640 nm. The pattern generated is the five points 191, 192, 193, 194, 195 illustrated in FIG. 11. It is critical that at least the ratio of distances between the five points remain constant. If the size of the pattern changes based on distance between the object and the active illumination device, is may become necessary to be able to detect the distance from the object. In one embodiment, the DOE design described above: the θ_{V} 206 and 208 and θ_{H} 202 and 204 values are Fifteen degrees (15.0°). In another design these angles were 11 degrees (11°) rather than 15. In other embodiments a 530 nm green laser was employed. It should be appreciated that these are just two of many possible options.

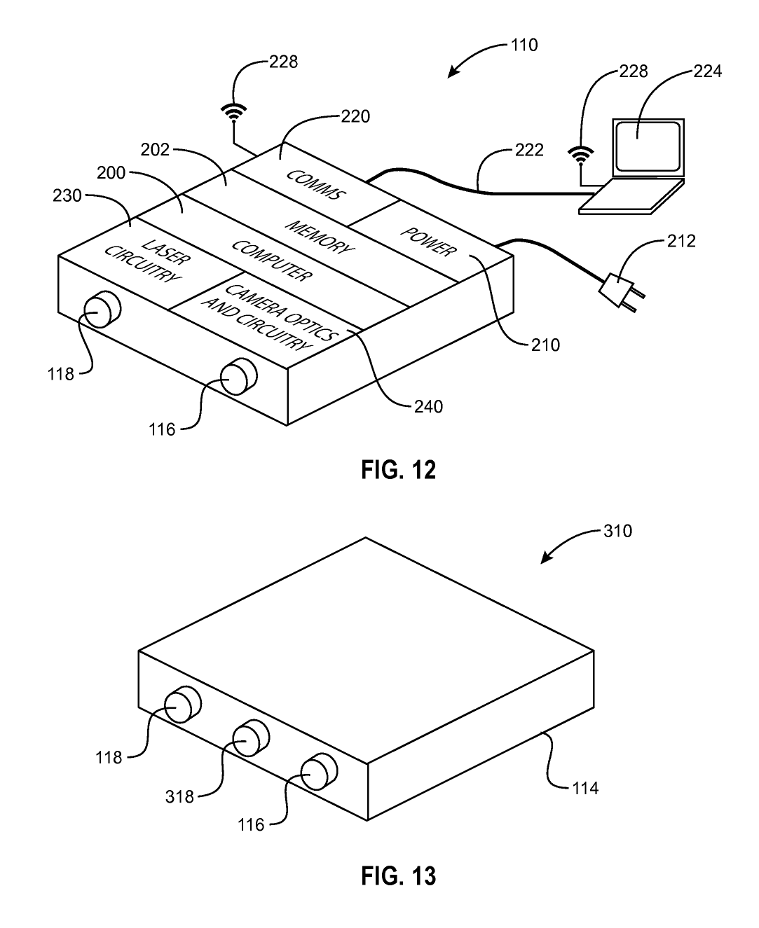

Other major components of the orthographic image capture system 110 are a computer and computer instruction sets (software) which perform processing of the image data collected by the camera 116. In the embodiment illustrated in FIG. 12, the computer is located in the same housing as the camera 116 and active illumination system 118. In this embodiment the housing also contains a power supply and supporting circuitry for powering the device and connection(s) 212 for charging the power supply. The system 110 also includes communications circuitry 220 to communicate with wired 222 to other electronic devices 224 or wirelessly 228. The system 110 also includes memory(s) for storing instructions and picture data and supporting other functions of the system 110. The system 110 also includes circuitry 230 for supporting the active illumination system 118 and circuitry 240 for supporting the digital camera.

In the embodiment shown, all of the processing is handled by the CPU (not shown) in the on-board computer 200. However in other embodiments the processing tasks may be partially or totally performed by firmware programmed processors. In other embodiments, the onboard processors may perform some tasks and outside processors may perform other tasks. For example, the onboard processors may identify the locations of illumination pattern in the picture. Calculate corrections due to the non-orthographic image save the information and send it to another computer or data processors to complete other data processing tasks.

### D. Computer

The orthographic image capture system 110 requires that data processing tasks be performed, Regardless of the location of the data processing components or how the tasks are divided, data processing tasks must be accomplished.. In the embodiment shown, an onboard computer 200, no external processing is required. However, the data can be exported to another digital device 224 which can perform the same or additional data processing tasks. For these purposes, a computer is a programmable machine designed to automatically carry out a sequence of arithmetic or logical operations. The particular sequence of operations can be changed readily, allowing the computer to solve more than one kind of problem.

### E. Software

This is a process system, that allows for information or data to be manipulated in a desired fashion, via a programmable interface, with inputs, and results. The software system controls calibration, operation, timing, camera and active illumination control, data capture processing, data display and export.

Computer software or just software, is a collection of computer programs and related data that provides the instructions for telling a computer what to do and how to do it.

### F. Calibration System

This is an item, which is used to provide a sensor system with ground truth information, which is used as a reference data point, for information acquired by the sensor system. Integration and processing of calibration data and operation data, forms corrected output data.

One embodiment of a suitable calibration system employs a specific physical item (Image board) that is of a predetermined size, and shape, which has a specifically patterned or textured surface, and known geometric properties. The Active illumination system emits radiation in a known pattern with fixed geometric properties, upon the Image Board or upon a scene that contains the Image Board, in conjunction with information provided by an optional Distance Tool, with multiple pose and distance configurations, a Calibration map is processed and defined for the imaging system.

The calibration board may be a flat surface containing a superimposed image, a complex manifold surface, containing a superimposed image, an image that is displayed upon via a computer monitor, television, or other image projection device or a physical object that has a pattern of features or physical attributes with known geometric properties. The calibration board may be any item that has unique geometry or textured surface that has a matching digital model.

### G. Connections of Main Elements and Sub-Elements of Invention

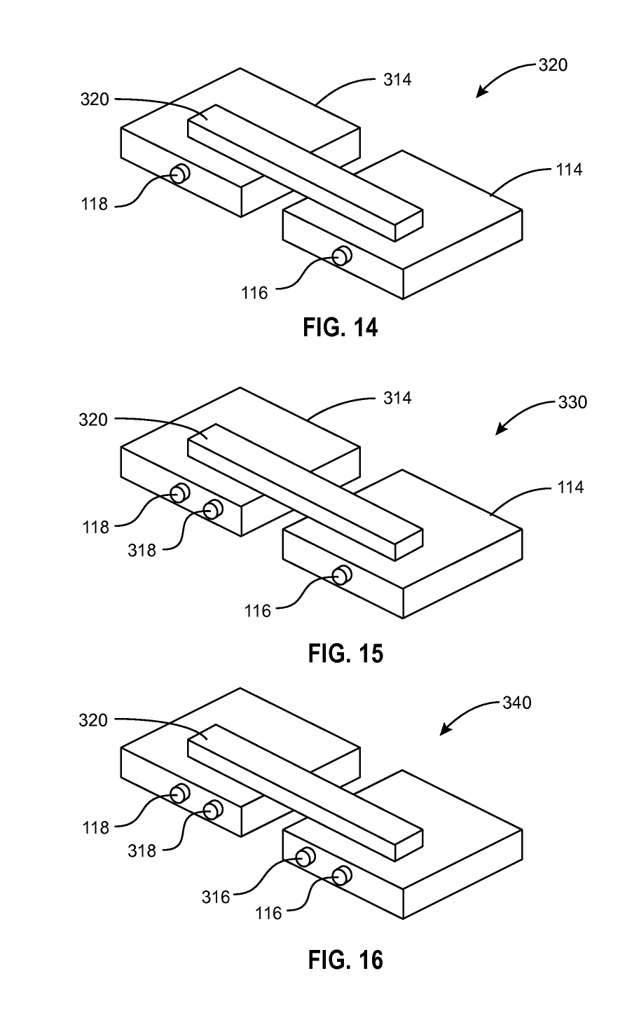

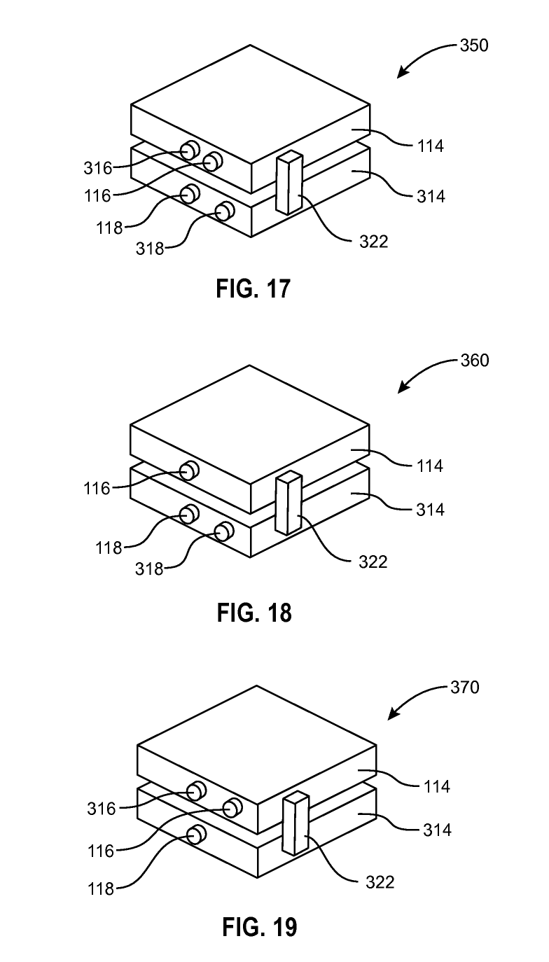

In the orthographic image capture system, the Camera(s) must be mechanically linked to the Active Illumination device(s). In the embodiment 110 illustrated in FIG. 1 and FIG. 12, the mechanical linkage is based on both the camera 116 and active illumination device 118 being in the same housing 114. This is also true of embodiment 310 illustrated in FIG. 13 where the Camera 116 is mechanically linked to the two active illumination devices 118 and 318 by their common housing 114. This would also be true in other embodiments where there are any other combination of cameras and or active image devices. FIG. 14, FIG. 15 and FIG. 16 have cameras and active illumination devices in separate housings 114 and 314 which are rigidly connected by adaptor 320 which fix the respective cameras 116, 316 and active illumination devices 118 and 318 relative to each other so that. Camera and Active Illumination devices have overlapping fields of view, through the useable range of the orthographic image capture system. FIG. 17, FIG. 18 and FIG. 19 illustrate embodiments where the mechanical linkage 322 is to housings which are horizontally configured.

In addition to being mechanically linked, it is preferable though not essential that the Camera and Active Illumination devices are Electrically linked. In the embodiment illustrated in FIG. 13, the two types of devices (camera(s) and active illumination device(s)) are linked through their respective support circuitry 230 and 240 via the computer 200. Where the devices are in separate housings, there may be a data linkage (not shown) in addition to the mechanical linkage 320 or 322. These linkages are desirable in order to coordinate in a synchronous manner the active illumination and camera image capture functions.

The calibration is accomplished by capturing multiple known Image Board and Distance data images.

### H. Further Embodiments of the Orthographic Image Capture System

The Camera(s) Active Illumination device(s) and Software may be integrated with the computer, software and software controllers within a single electro mechanical device such as a laptop, tablet, phone, PDA.

The Active Illumination device(s) may be an additional module, added as clamps, shells, sleeves or any similar modification to a device that already has a camera computer and software to which the orthographic image capture system software can be added.

The Camera(s) and Active Illumination device(s) may have overlapping optical paths with common fields of view, and this may be modified by multiple assemblies of: Camera or Active Illumination, combined in a fixed array. This provides a means to capture enough information to make corrections to the image based on distortions to the image caused by the optics of the camera, for example to correct the pincushion or barrel distortion of a telephoto, wide angle, or fish eye lens, as well as other optical aberrations such as astigmatism and coma.

The triggering of the Active illumination may be synchronized with the panoramic view image capturing to capture multiple planar surfaces in a panoramic scene such as all of the walls of a room.

Lens Systems and Filter System, Active Illumination, devices with different diffractive optical element can be added to or substituted for existing optics on the Camera(s): Active Illumination devices to provide for different operable ranges and usage environments

Computer is electronically linked to Camera and Active Illumination with: Electrical And Command To Camera and Electrical And Command To Active Illumination. Power for: Camera and Active Illumination may be supplied and controlled by the Computer and Software.

### I. Operation of Preferred Embodiment 12

The user has an assembled or integrated Orthographic Image Capture System, consisting of all Cameras, Active Illumination Computer and Software elements, and sub-elements. The Active illumination pattern is a non-dynamic, fixed in geometry, and matches the pattern and geometry configuration used during the calibration process with Calibration System, Image Board and optional Distance Tool and Calibration Map. Calibration System, generates a unique. Calibration Data file, which is stored with the Software. The user aims Orthographic Image Capture System, in a pose, that allows the Camera and Active Illumination device to occupy the same physical space upon a selected predominantly planar surface, that is to be imaged. Computer and Software are then triggered by a software or hardware trigger, that sends instructions to Timing To Camera and Timing To Active Illumination, via Electrical And Command To Camera and Electrical And Command To Active Illumination, which then emits radiation that is focused, split or diffracted by the Active illumination Lens System, in a fixed geometric manner. The Camera may have a Filter System added or integral, which enables a more effective capture of the Active Illumination and Lens System emitted data, by reducing the background radiation, or limiting the radiation wavelengths that are captured by Camera for Software processing with reduced signal to noise ratios. The data capture procedure delivers information for processing into Raw Data. The Raw Data is integrated with Calibration Data with Calibration Processing, to generate Export Data and Display Data. The Export Data and Display Data is a common file format image file, which has been displayed in corrected world coordinates where each pixel has a known dimension and aspect ratio, or the untransformed image of the scene with selected dimensional information that has been transformed into corrected world coordinates, or integrated with other similarly corrected images in a fashion that form natural relative scalar qualities in 2 dimensions.

The Orthographic Image Capture System may consist of a plurality of Cameras, and Active Illumination elements that are mounted in an array that is calibrated under a Calibration System.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

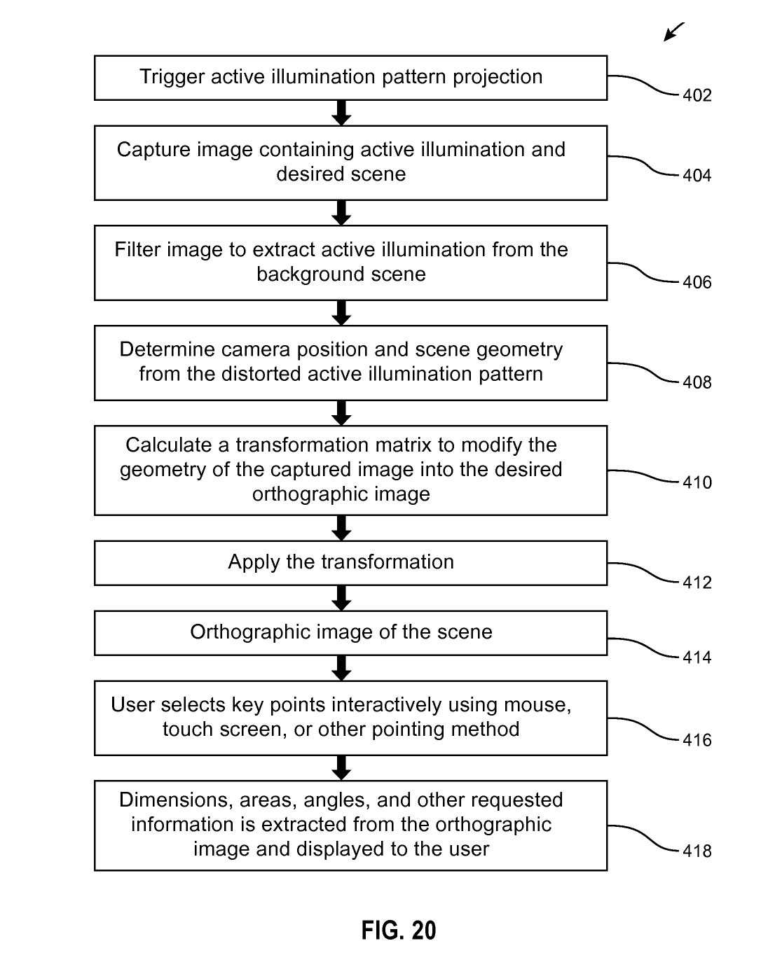

FIG. 20 illustrates a flow chart 400 of major data processing steps for the software and hardware of an orthographic image capture system. The first step illustrated is a synchronized triggering of the active imaging device onto the planar object 402. The next step is capturing of the digital image containing the active imaging pattern 404. The next step is processing the image data to extract the position of characteristic elements of the active imaging pattern 406. The software then calculates a transformation matrix and the non-orthographic orientation and position of the camera relative to the plane of the object 408 and 410. These are calculable based on determining the distortions and position shift to the pattern imaged and determining corrections that would restore the geometric ratios of the active illumination pattern. Information about the distance to the imaged surface is also contained in the imaged pattern. In this embodiment the software creates a transformed image of the object as though the picture was taken from a virtual orthographic viewing angle on the object and present the view to the user 412 and 414. The user is then provided with an opportunity to select key points of dimensional interest in the image using a mouse and keyboard and/or any other similar means such as a touch screen 416. The software processes these points and provides the user with the actual dimensional information based on the dimensional points of interest selected by the user 418.

An example of the last two steps is illustrated in FIG. 22. Where the user has selected the area of the wall 450 minus the three windows 452, 454, 456 and provided with an answer of 114 square feet.

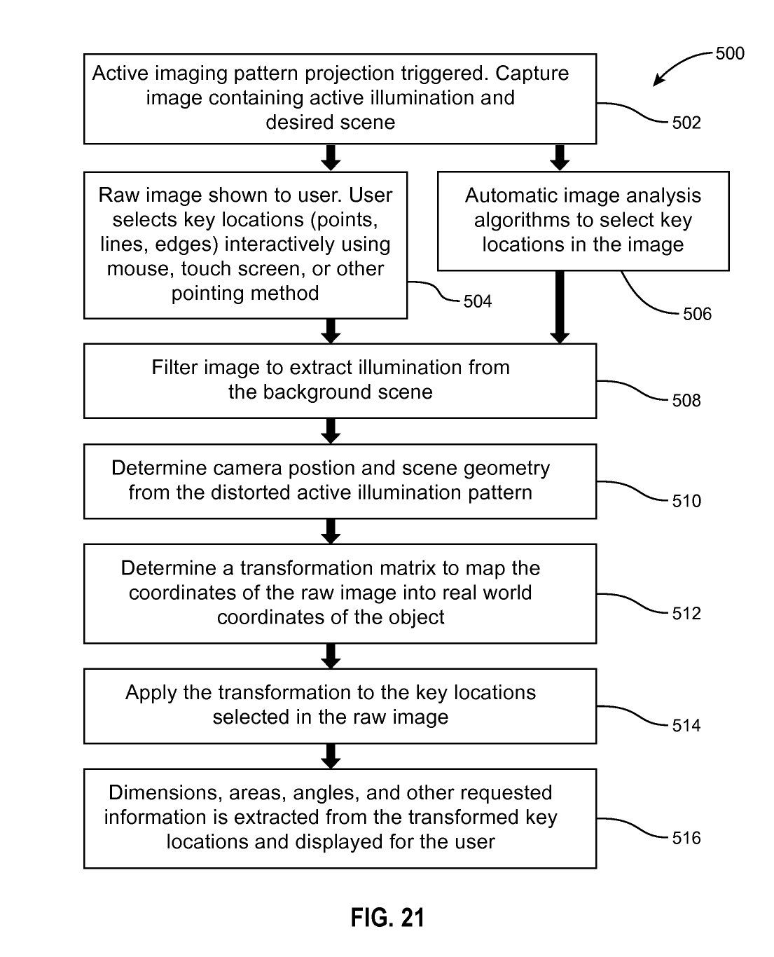

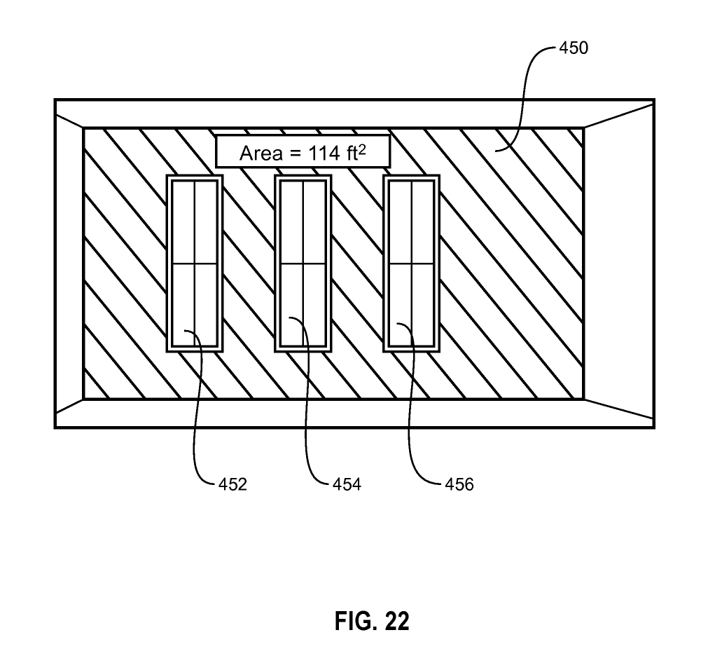

FIG. 21 illustrates an alternative embodiment of the data processing flow of a software implementation of an orthographic image capture system. First the active image pattern projection is triggered and the image is captured. Then the flow can proceed down two paths or one of two paths. The first path the user is shown the raw image and selects key dimension points of interest 504. The second path is that a separate routine automatically identifies key dimensional locations in the image 506. Meanwhile the software is analyzing the image to locate key geometric points of interest in the active illumination pattern projected on the imaged object 508. The software then determines a transformation matrix and scene geometry 510 and 512. The software then applies the transformation matrix to the key points of dimensional interest that were automatically determined and/or input by the user 514 and then the software presents the user with dimensional information requested or automatically selected in step 506.

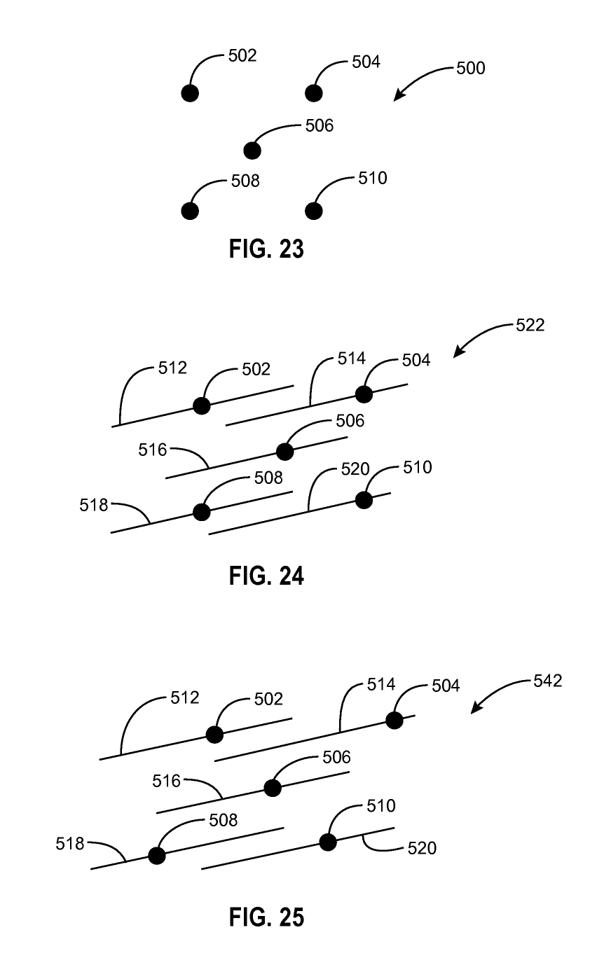

FIG. 23 illustrates the same undistorted pattern illustrated in FIG. 4. FIG. 24 and FIG. 25 illustrate examples of distortion of the pattern in an embodiment of the orthographic image capture system employing the fixed relationship of the camera and an active illumination device described in A Simple Method for Range Finding via Laser Triangulation by Hoa G. Nguyen and Michael R Blackburn, Technical Document 2734 dated January 1995 published by the United States Naval Command, Control and Ocean Surveillance Center, RDT&E Division and NRAD attached hereto as Appendix A.

The distortion(s) illustrated in FIG. 24 reflect a camera angle similar to the angle illustrated in FIG. 1: of a wall—taken from the left angled to right (horizontal pan right and horizontal to the wall (ie. no vertical tilt up or down).

The distortion(s) illustrated in FIG. 25 reflect a camera angle similar to the angle illustrated in FIG. 1: of a wall—taken from the left angled to right (horizontal pan right) and but with the cameral lowered and looking up at the wall (ie. vertical tilt up). Note that the points in the pattern 502, 504, 506, 508 move along line segments 512, 514, 516 and 518 respectively.

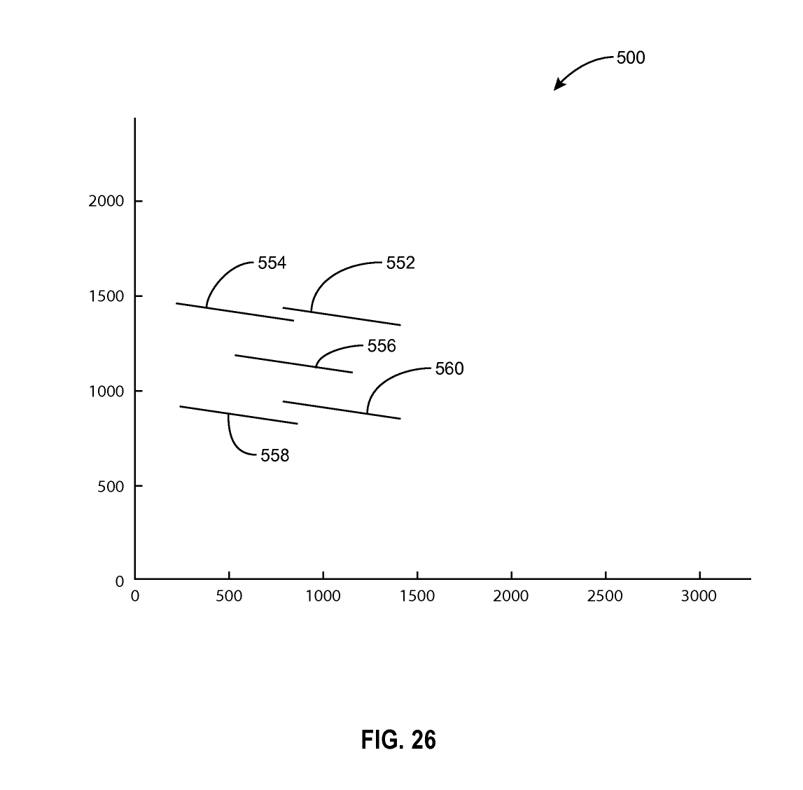

In a further embodiment of the embodiment illustrated in FIG. 24 and FIG. 25, Filtering image for the active illumination pattern steps (406 in FIG. 20 and 408 in FIG. 21) can be limited for a search for pixels proximate to the line segments 552, 554, 556, 558, and 560 illustrated in FIG. 26. This limited area of search, greatly speeds up pattern filtering step(s). In FIG. 26, the horizontal x axis represents the horizontal camera pixels, and the vertical y axis represents the vertical camera pixels and the line segments 552, 554, 556, 558 represent the coordinate along which the laser points may be found and thus the areas proximate to these line segments is where the search of laser points can be concentrated.

In the embodiment shown in FIG. 24, FIG. 25 and FIG. 26, the fixed projection axis of the active illuminator is slightly offset from the optical axis of the camera, which is useful in obtaining range information as described in Appendix A. Furthermore, the direction of the projection axis of the active illuminator relative to the camera axis has been chosen based on the particular pattern of active illumination such that, as the images of the active illumination dots shift on the camera sensor over the distance range of the orthographic image capture system, the lines of pixels on the camera sensor over which they shift do not intersect. In this particular example, the line segments 512 and 514 and 518 and 520 do not intersect. This decreases the chance of ambiguity, i.e., of confusing one spot for another in the active illumination pattern. This may be particularly helpful where the active illuminator is a laser which is fitted with a DOE which are prone to produce “ghost images”.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

1. (canceled)

2. A measurement tool for determining dimensional measurements and geometric properties of object(s) or region(s) in a 2D plane in a scene comprising:
a visible light digital camera;
an attached light pattern projector projecting a known deterministic pattern;
a data processing system; and improvements comprising:
the centroid of the pattern significantly displaced from the centroid of the camera's field of view, but still within the field of view on the 2D plane in the scene;
the data processing system
a. recognizes the projected light pattern and,
b. due to distortions in the pattern, determines the camera's location and pose relative to the generally planar surface onto which the pattern is projected
c. computes actual dimensions and/or other geometric properties of object(s) or region(s) in the 2 dimensional plane imaged in the photograph.

3. The measurement tool of claim 2 where the pattern is a pattern of dots.

4. The measurement tool of claim 3 where the pattern is comprised of 5 dots in the form of a rectangle with a central dot.

5. The measurement tool of claim 2 where the pattern projected is visible.

6. The measurement tool of claim 2 where the pattern projected is not visible to the human eye but detectible by the data processing system.

7. The measurement tool of claim 2 where the dimension measured is the distance between two objects.

8. The measurement tool of claim 2 where the dimension measured is a dimension of an object.

9. The measurement tool of claim 2 where the geometric property is the area of the object in the 2 dimensional plane imaged.

10. The measurement tool of claim 2 the data processing system determines the 3×3 perspective transformation that maps points in the camera image to points in the real world coordinates of the 2D scene.

11. The measurement tool of claim 2 where the data processing system creates a file with the photograph and the 3×3 transformation coefficients as well as any specific dimensions or measurement information that is required for a given application or is requested by the user.)

12. The measurement tool of claim 3 where the recognizing the projected light pattern is expedited during the pattern recognition process by limiting the search to pixels proximate to non-intersecting line segments along which the dots are expected to be found.
